(19) United States
(12) Patent Application Publication
(10) Pub. No.: US 2016/0202622 A1
(43) Pub. Date: Jul. 14, 2016

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Sakiko HIRAI, Kanagawa (JP); Shotaro TAKAHASHI, Kanagawa (JP); Yukiaki NAKAMURA, Kanagawa (JP); Masaru TAKAHASHI, Kanagawa (JP)

(21) Appl. No.: 14/791,963

(22) Filed: Jul. 6, 2015

(30) Foreign Application Priority Data
Jan. 9, 2015 (JP) 2015-003320

(51) Int. Cl. G03G 9/00

(52) U.S. Cl. CPC G03G 9/0926; G03G 9/0827; G03G 9/0819

(57) ABSTRACT

An electrostatic charge image developing toner includes: first particles containing a brilliant pigment; and second particles not containing a brilliant pigment, wherein 80% by number or greater of the first particles has a circularity in a range of from 0.850 to 0.940, and 80% by number or greater of the second particles has a circularity of 0.950 or greater.

### CROSS-REFERENCE TO RELATED APPLICATIONS

This application is based on and claims priority under 35 USC 119 from Japanese Patent Application No. 2015-003320 filed Jan. 9, 2015.

### BACKGROUND

1. Technical Field

The present invention relates to an electrostatic charge image developing toner, an electrostatic charge image developer, and a toner cartridge.

2. Related Art

A brilliant toner is used for forming an image having metal gloss.

### SUMMARY

According to an aspect of the invention, there is provided an electrostatic charge image developing toner including:

first particles containing a brilliant pigment; and

second particles not containing a brilliant pigment,

wherein 80% by number or greater of the first particles has a circularity in a range of from 0.850 to 0.940, and

80% by number or greater of the second particles has a circularity of 0.950 or greater.

### BRIEF DESCRIPTION OF THE DRAWINGS

Exemplary embodiments of the present invention will be described in detail based on the following figures, wherein:

FIG. 1 is a sectional view schematically showing an example of a brilliant toner particle included in the toner according to the exemplary embodiment;

FIG. 2 is a configuration diagram showing an example of an image forming apparatus according to the exemplary embodiment; and

FIG. 3 is a configuration diagram showing an example of a process cartridge according to the exemplary embodiment.

### DETAILED DESCRIPTION

Hereinafter, the exemplary embodiments of the invention will be described. However, these description and Examples are for illustrating the present invention, and are not intended to limit the scope of the invention.

In the present specification, “(meth)acryl” indicates acryl or methacryl, “(meth)acrylic acid” indicates acrylic acid or methacrylic acid, and “(meth)acrylo” indicates acrylo or methacrylo.

Toner for Electrostatic Charge Image Development

The electrostatic charge image developing toner (also referred to as “toner”) according to the exemplary embodiment is a brilliant toner including particles containing a brilliant pigment (also referred to as “first particles” or “brilliant toner particles”) and particles not containing a brilliant pigment (also referred to as “second particles” or “non-brilliant toner particles”). In addition, in the toner according to the exemplary embodiment, 80% by number or greater of the first particles has a circularity from 0.850 to 0.940, and 80% by number or greater of the second particles has a circularity of 0.950 or greater. By this configuration, the toner according to the exemplary embodiment prevents an occurrence of color points.

In the related art, brilliant toners including brilliant toner particles are known. The brilliant toner particles preferably have a low circularity from the viewpoint of increasing a brilliant feeling of an image. On the other hand, the fluidity and the transfer properties of the toner tends to deteriorate as the circularity of the brilliant toner particles is lowered, aggregate of the brilliant toner is produced in the toner cartridge or the developing device when repeatedly forming images, and a part of these is moved to and remains on the photoreceptor surface, and, as a result, an image defect in which color points appear on the recording medium occurs over time. In particular, in a case where the brilliant toner remains under high temperature and high humidity conditions, this tendency becomes stronger.

In contrast, in the toner according to the exemplary embodiment, 80% by number or greater of the non-brilliant toner particles, which is used in combination with the brilliant toner particles of which 80% by number or greater has a circularity from 0.850 to 0.940, has a circularity of 0.950. It is considered that by using the non-brilliant toner particles (that is, the toner particles having less irregularities on the surfaces and having a nearly spherical shape compared to the brilliant toner particles) having the circularity distribution in combination with the brilliant toner particles, the fluidity and the transfer properties of the toner are improved, and, as a result, an occurrence of color points are prevented even in the case of repeatedly forming images.

More specifically, while maintaining the brilliance of an image by the brilliant toner having a circularity of 0.850 to 0.940, deterioration of the fluidity of the toner is prevented by the non-brilliant toner having a circularity of 0.950 or greater. At the same time, the non-brilliant toner which is developed in an amount capable of maintaining the brilliance of the image relatively reduces the contact area of the entirety of the toner image developed with the photoreceptor surface, and due to this, deterioration of the transfer properties is prevented.

The toners typically have different developing properties or the transfer properties depending on the type, the shape, the particle diameter, or the like, and, in general, a toner having a large particle diameter is likely to be developed, and a toner having a spherical shape is likely to be transferred. In the exemplary embodiment, based on these tendencies, the proportion of the toner particles not containing the brilliant pigment in the entirety of toner particles is preferably 5% by number to 80% by number, and when the proportion is within the above range, it is possible to more effectively maintain the brilliance and prevent an occurrence of the color points.

In the toner according to the exemplary embodiment, the volume average particle diameter of the brilliant toner particles is preferably 5 μm to 30 μm. When the volume average particle diameter of the brilliant toner particles is 5 μm or greater, the brilliant feeling of an image is more favorable. On the other hand, when the volume average particle diameter of the brilliant toner particles is 30 μm or less, color points is less likely to occur. From the viewpoint described above, the volume average particle diameter of the brilliant toner particles is preferably from 5 μm to 30 μm, and more preferably from 7 μm to 25 μm.

In the toner according to the exemplary embodiment, the volume average particle diameter of the non-brilliant toner particles is preferably 1 μm to 15 μm. When the volume average particle diameter of the non-brilliant toner particles is 1 μm or greater, the transfer properties of the toner is favorable, and thus, the brilliant feeling of an image is likely to be maintained. On the other hand, when the volume average particle diameter of the non-brilliant toner particles is 15 with or less, color points are less likely to occur. From the viewpoint described above, the volume average particle diameter of the non-brilliant toner particles is preferably from 1 μm to 15 μm, and more preferably from 3 μm to 12 μm.

In the toner according to the exemplary embodiment, from the viewpoint of a more difficult occurrence of color points, it is preferable that the volume average particle diameter of the non-brilliant toner particles is smaller than the volume average particle diameter of the brilliant toner particles.

In the toner according to the exemplary embodiment, from the viewpoint of the balance among the brilliant feeling of an image, the transfer properties of the toner and prevention of an occurrence of color points, the proportion of the non-brilliant toner particles in the entirety of toner particles is preferably from 5% by number to 80% by number, more preferably from 10% by number to 50% by number, still more preferably from 15% by number to 40% by number, and most preferably from 8% by number to 40% by number.

In the toner according to the exemplary embodiment, from the viewpoint of the cleaning properties of a photoreceptor or an intermediate transfer member, the circularity of the non-brilliant toner particles is preferably less than 1, and 80% by number or greater of the non-brilliant toner particles preferably has a circularity from 0.950 to 0.990.

The analysis of the toner particles included in the toner according to the exemplary embodiment is performed on a dispersion (for example, COULTER ISOTON II Diluent, manufactured by Beckman Coulter Inc.) obtained by dispersing a toner in a dispersion medium as a sample using a flow-type particle image analyzer (FPIA-3000, manufactured by Sysmex Corporation).

When observing using the flow-type particle image analyzer, the toner particles appear dark in the case of containing the brilliant pigment, and the toner particles appear bright in the case of not containing the brilliant pigment. Due to this, the toner particles are distinguished into two types of brilliant toner particles and non-brilliant toner particles. By performing image analysis on toner particles of the total 4,500 or greater, each circularity distribution of two types of toner particles, each volume average particle diameter (m) of two types of toner particles, and the proportion (% by number) of the non-brilliant toner particles in the entirety of toner particles are determined.

The circularity distribution of the toner particles is obtained by calculating circularity (=perimeter of a circle having the same area as the area of a toner particle image/perimeter of a toner particle image) of each of the toner particles.

The circularity distribution of the toner particles, the volume average particle diameter of the toner particles, and the proportion of the non-brilliant toner particles in the entirety of toner particles may be controlled by adjusting various conditions in preparing steps of the toner particles. The details will be described in “Preparing Method of Toner”.

The toner according to the exemplary embodiment includes toner particles, and may further include an external additive. That is, in the exemplary embodiment, the toner may be formed of only the toner particles, or the toner obtained by externally adding an external additive to the toner particles may be used. In the exemplary embodiment, the analysis of the toner particles is performed in a state of not including an external additive to determine the circularity distribution of the toner particles, the volume average particle diameter of the toner particles, and the proportion of the non-brilliant toner particles in the entirety of toner particles. For the toner obtained by externally adding an external additive to the toner particles, first, the external additive is removed, and then, the toner particles are analyzed. In this case, 1 g of a toner is dispersed in an aqueous solution including a surfactant, then, the external additive is removed from the toner particles by applying ultrasonic waves using an ultrasonic dispersing apparatus (RUS-600TCVP, manufactured by Nihon Seiki Kaisha Ltd.), and after the dispersion is passed through a filter paper, the residue on the filter paper is washed with ion exchange water and dried, whereby toner particles are obtained.

In the toner according to the exemplary embodiment, in a case of forming a solid image, the ratio (A/B) of a reflectance A at a light receiving angle of +30° to a reflectance B at a light receiving angle of −30° measured when irradiating with an incident light having an incident angle of −45° using a goniophotometer with respect to the image is preferably from 2 to 100.

The fact that the ratio (A/B) is 2 or greater represents that reflectance to the opposite side (the light receiving angle is the positive side) to the side on which an incident light is incident is greater than reflectance to the side (the light receiving angle is the negative side) on which an incident light is incident, and represents that diffused reflection of the light incident is prevented. In a case where diffused reflection in which the light incident is reflected in various directions occurs, the color appears dull when visually observing the reflected light. Therefore, in a case where the ratio (A/B) is 2 or greater, when visually observing the reflected light, glossiness is observed, and thus, brilliance is excellent. In contrast, when the ratio (A/B) is 100 or less, a viewing angle capable of visually observing the reflected light does not become too narrow, and thus, the phenomenon in which the color appears blackish depending on the angle is less likely to occur.

From the above-described viewpoint, the ratio (A/B) is preferably 2 to 100, more preferably 5 to 80, still more preferably 10 to 50, and particularly preferably 10 to 40.

Measurement of Ratio (A/B) by Goniophotometer

First, the angle of incidence and the light receiving angle will be described. When measuring the ratio with a goniophotometer in the exemplary embodiment, the angle of incidence is set to −45°, and this is because high measurement sensitivity is obtained with respect to an image with a wide range of glossiness.

In addition, the light receiving angle is set to −30° and to +30° because the measurement sensitivity is highest when evaluating an image with a brilliant property and an image with no brilliant property.

Then, a method for measuring the ratio (A/B) will be described.

In the exemplary embodiment, when measuring the ratio (A/B), first, a “solid image” is formed by the following method. A developing device DOCUCENTRE-III C7600 manufactured by Fuji Xerox Co., Ltd. is filled with the developer as a sample and a solid image having a toner applied amount of 4.5 g/cm² is formed on paper (OK topcoat+paper manufactured by Oji Paper Co., Ltd.) at a fixing temperature of 190° C. and a load during fixing of 4.0 kg/cm². The “solid image” refers to an image having a density of 100%.

An image part of the formed solid image is irradiated with the incident light at an angle of incidence of −45° with respect to the solid image, and a reflectance A at a light receiving angle of +30° and a reflectance B at a light receiving angle of −30° are measured by using a spectral varied angle color-difference meter GC5000L manufactured by Nippon Denshoku Industries Co., Ltd as a goniophotometer. Each of the reflectance A and the reflectance B is measured with light having a wavelength of 400 nm to 700 nm at intervals of 20 nm, and defined as an average of the reflectances at respective wavelengths. The ratio (A/B) is calculated from these measurement results.

In the toner according to the exemplary embodiment, the proportion of the non-brilliant toner particles in the entirety of toner particles is preferably from 5% by number to 80% by number, more preferably from 10% by number to 50% by number, still more preferably from 15% by number to 40% by number, still more preferably from 15% by number to 30% by number, and still more preferably from 20% by number to 30% by number from the viewpoint of satisfying the above-described range of the ratio (A/B).

In addition, in the toner according to the exemplary embodiment, the brilliant toner particles preferably satisfy the following requirements (1) and (2) from the viewpoint of satisfying the above-described range of the ratio (A/B).

(1) The brilliant toner particles have an average equivalent circle diameter longer than an average maximum thickness.

(2) In a case where a cross section in the thickness direction of the brilliant toner particle is observed, the proportion of the brilliant pigment in which an angle between the long axis direction on a cross section of the brilliant toner particle and the long axis direction of the brilliant pigment is within a range of from −30° to +30° is 60% or greater in the entirety of brilliant pigments observed.

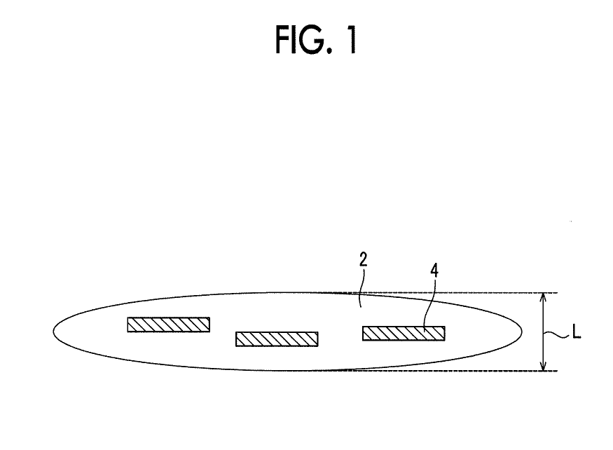

FIG. 1 is a sectional view schematically showing an example of a brilliant toner particle satisfying the above requirements (1) and (2). The schematic view shown in FIG. 1 is a sectional view in the thickness direction of the brilliant toner particle. The brilliant toner particle 2 shown in FIG. 1 is a toner particle having a flake shape in which the equivalent circle diameter is longer than the maximum thickness L, and contains brilliant pigments 4 having a flake shape (specifically, a scale shape).

As shown in FIG. 1, it is considered that the brilliant toner particle 2 having a flake shape in which the equivalent circle diameter is longer than the maximum thickness L is arranged on a recording medium such that the flake surface side thereof faces the surface of the recording medium and fixed. Therefore, it is considered that a brilliant pigment satisfying the above requirement (2) among the brilliant pigments having a scale shape contained in the brilliant toner particle 2 is arranged such that the surface side having the maximum area faces the surface of the recording medium. It is considered that in a case where an image formed in this manner is irradiated with light, the proportion of the brilliant pigment irregularly reflecting with respect to the incident light is prevented, and thus, the above-described range of the ratio (A/B) is achieved. In addition, when the proportion of the brilliant pigment irregularly reflecting with respect to the incident light is prevented, the intensity of the reflected light varies greatly depending on the viewing angle, and thus, a more ideal brilliance is obtained.

As shown in (1) described above, it is preferable that the brilliant toner particles of this exemplary embodiment has the average equivalent circle diameter D which is greater than the average maximum thickness C. Furthermore, a ratio (C/D) of the average maximum thickness C to the average equivalent circle diameter D is preferably in a range of 0.001 to 0.300.

The average maximum thickness C and the average equivalent circle diameter D described above are measured by the following method.

The brilliant toner is applied to a smooth surface and is dispersed with vibration so as not to have unevenness. 1000 brilliant toner particles are observed with a color laser microscope “VK-9700” (manufactured by Keyence Corporation) with a magnification power of 1000, the maximum thickness C and the equivalent circle diameter D of a top view are measured, and arithmetic average values thereof are calculated to obtain the average maximum thickness C and the average equivalent circle diameter D.

Hereinafter, the configuration of the toner according to the exemplary embodiment will be described in detail.

Toner Particles

The brilliant toner particles preferably have an aspect in which the brilliant pigment is bound by a binder resin, and may further contain a colorant, a release agent, or other internal additives.

The non-brilliant toner particles contain at least a binder resin, and may further contain a colorant, a release agent, or other internal additives. The amount of the brilliant pigment in the non-brilliant toner particles is under the detection limit, and thus, the non-brilliant toner particles substantially do not include the brilliant pigment.

Brilliant Pigment

The brilliant pigment is a pigment exhibiting brilliance. Examples of the brilliant pigment include powders of metals such as aluminum, brass, bronze, nickel, stainless steel, and zinc; mica coated with titanium oxide, yellow iron oxide, or the like; flaky crystals or plate crystals such as aluminosilicate, basic carbonate, barium sulfate, titanium oxide, and bismuth oxychloride; a flaky glass powder, a flaky glass powder which is metal-deposited; and guanine crystal. Among these, the metal powder is preferable from the viewpoint of the mirror reflection intensity, and the flake shape metal powder is preferable from the viewpoint of further increasing the mirror reflection intensity. Among the metal powders, an aluminum powder is preferable from the viewpoint of easily obtaining a flake shape powder. The surface of the metal powder may be coated with silica, an acrylic resin, a polyester resin, or the like.

The content of the brilliant pigment in the brilliant toner particles is, for example, from 1% by weight to 70% by weight, from 5% by weight to 50% by weight, and from 5% by weight to 30% by weight.

Binder Resin

Examples of the binder resin of the toner particles include a polyester resin, an epoxy resin, a polyurethane resin, a polyamide resin, a cellulose resin, a polyether resin, polystyrene, a styrene-alkyl (meth)acrylate copolymer, a styrene-(meth)acrylonitrile copolymer, a styrene-butadiene copolymer, and a styrene-maleic anhydride copolymer. These resins may be used alone or in combination of two or more types thereof. The binder resin for the brilliant toner particles and the binder resin for the non-brilliant toner particles may be the same as or different from each other.

As the binder resin, a polyester resin is suitable. Examples of the polyester resin include a polycondensate of a polycarboxylic acid and a polyol. As the polyester resin, a commercially available product may be used or a synthesized polyester resin may be used.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is determined from a DSC curve obtained by differential scanning calorimetry (DSC). More specifically, the glass transition temperature is determined by “Extrapolated Starting Temperature of Glass Transition” described in a method for determining a glass transition temperature of “Testing Methods for Transition Temperatures of Plastics” in JIS K 7121-1987.

The weight average molecular weight (Mw) of the polyester resin is preferably from 5,000 to 1,000,000, and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100, and more preferably from 2 to 60.

The weight average molecular weight and the number average molecular weight of the resin are measured by gel permeation chromatography (GPC). The molecular weight measurement by GPC is performed by using HLC-8120 manufactured by Tosoh Corporation as a measuring device, TSKGEL SUPER HM-M (15 cm) manufactured by Tosoh Corporation as a column, and tetrahydrofuran as a solvent. The weight average molecular weight and the number average molecular weight are calculated by using a molecular weight calibration curve prepared by monodisperse polystyrene standard samples from the measurement results.

The content of the binder resin is, for example, preferably from 40% by weight to 95% by weight, more preferably from 50% by weight to 90% by weight, and still more preferably from 60% by weight to 85% by weight, with respect to the total toner particles.

Colorant

Examples of the colorant include pigments such as carbon black, chrome yellow, hansa yellow, benzidine yellow, threne yellow, quinoline yellow, pigment yellow, permanent orange GTR, pyrazolone orange, vulcan orange, watching red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazole dye. The colorants may be used alone or two or more types may be used in combination.

As the colorant, a surface-treated colorant may be used as necessary, or the colorant may be used in combination with a dispersing agent.

The content of the colorant is, for example, preferably from 1% by weight to 30% by weight, and more preferably from 3% by weight to 15% by weight, with respect to the total toner particles.

Release Agent

Examples of the release agent include hydrocarbon waxes; natural waxes such as a carnauba wax, a rice wax, and a candelilla wax; synthetic or mineral-petroleum waxes such as a montan wax; and ester waxes such as fatty acid ester and montanic acid ester. However, the release agent is not limited thereto.

The melting temperature of the release agent is preferably from 50° C. to 110° C., and more preferably from 60° C. to 100° C.

The melting temperature of the release agent is determined by “Melting Peak Temperature” described in a method for determining a melting temperature of “Testing Methods for Transition Temperatures of Plastics” in JIS K 7121-1987 from a DSC curve obtained by differential scanning calorimetry (DSC).

The content of the release agent is, for example, preferably from 1% by weight to 20% by weight, and more preferably from 5% by weight to 15% by weight, with respect to the total toner particles.

Other Additives

Examples of other additives include known additives such as a magnetic material, a charge-controlling agent, and inorganic powder. These additives are included in the toner particles as an internal additive.

Characteristics of Toner Particles

The toner particles may be toner particles having a single-layer structure, or toner particles having a so-called core/shell structure configured of a core (core particle) and a coating layer (shell layer) covering the core. The toner particles having a core/shell structure may be configured to have a core configured to include a binder resin and, as necessary, other additives such as a colorant and a release agent, and a coating layer configured to include a binder resin.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O—(TiO₂)ₙ Al₂O₃.2SiO₂, CaCO₃, MgCO₃, BaSO₄, and MgSO₄.

Surfaces of the inorganic particles as an external additive are preferably treated with a hydrophobizing agent. The hydrophobizing treatment is performed by, for example, dipping the inorganic particles in a hydrophobizing agent. The hydrophobizing agent is not particularly limited, and examples thereof include a silane coupling agent, silicone oil, a titanate coupling agent, and an aluminum coupling agent. These may be used alone or in combination of two or more types thereof.

The amount of the hydrophobizing agent is, for example, from 1 part by weight to 10 parts by weight with respect to 100 parts by weight of the inorganic particles.

Examples of the external additive include resin particles (resin particles such as polystyrene particles, PMMA particles, and melamine resin particles) and cleaning aids (for example, metal salts of higher fatty acids represented by zinc stearate and particles of a fluorine polymer).

The amount of an external additive externally added is, for example, preferably from 0.01% by weight to 5% by weight, and more preferably from 0.01% by weight to 2% by weight, with respect to the toner particles.

Preparing Method of Toner

As the toner according to the exemplary embodiment, after preparing toner particles, the toner formed of only the toner particles may be used, or the toner obtained by externally adding an external additive to the toner particles may be used.

The toner particles may be prepared by using any of a dry preparation method (for example, a kneading and pulverizing method) and a wet preparation method (for example, an aggregation and coalescence method, a suspension and polymerization method, and a dissolution and suspension method). The preparing method is not particularly limited to these preparing methods, and a known preparing method is employed. Among these, toner particles are preferably obtained by the aggregation and coalescence method.

The toner according to the exemplary embodiment may be prepared by separately preparing brilliant toner particles and non-brilliant toner particles by a known preparing method, and then, by mixing the two toner particles. Otherwise, the toner according to the exemplary embodiment may be prepared by preparing both brilliant toner particles and non-brilliant toner particles together.

In a case where the toner particles are prepared by an aggregation and coalescence method, for example, a toner particle group including both the brilliant toner particles and non-brilliant toner particles is prepared by the aggregation and coalescence method through the following steps.
Step of preparing a resin particle dispersion in which resin particles as a binder resin are dispersed (resin particle dispersion preparation step).
Step of preparing a brilliant pigment dispersion in which a brilliant pigment is dispersed (brilliant pigment dispersion preparation step).
Step of forming first aggregated particles by aggregating the resin particles and the brilliant pigment in the dispersion obtained by mixing the resin particle dispersion and the brilliant pigment dispersion (first aggregated particle forming step).
Step of forming second aggregated particles by aggregating the resin particles in the resin particle dispersion (second aggregated particle forming step).
Step of promoting aggregation of the first aggregated particles and aggregation of the second aggregated particles in the dispersion obtained by mixing the aggregated particle dispersion including the first aggregated particles and the aggregated particle dispersion including the second aggregated particles (aggregation promoting step).
Step of forming brilliant toner particles and non-brilliant toner particles by respectively coalescing the first aggregated particles and the second aggregated particles by heating the aggregated particle dispersion including the first aggregated particles in which aggregation is promoted and the second aggregated particles in which aggregation is promoted (coalescing step).

Hereinafter, each step will be described in detail.

Resin Particle Dispersion Preparation Step

According to a resin particle dispersion preparation step, a resin particle dispersion in which resin particles as a binder resin are dispersed is prepared. The resin particle dispersion is prepared by, for example, dispersing resin particles in a dispersion medium by a surfactant.

Examples of the dispersion medium used for the resin particle dispersion include aqueous mediums.

Examples of the aqueous mediums include water such as distilled water and ion exchange water, and alcohols. These may be used alone or in combination of two or more types thereof.

Examples of the surfactant include anionic surfactants such as sulfuric ester salt, sulfonate, phosphate ester, and soap anionic surfactants; cationic surfactants such as amine salt and quarternary ammonium salt cationic surfactants; and nonionic surfactants such as polyethylene glycol, alkyl phenol ethylene oxide adduct, and polyol nonionic surfactants. Among these, anionic surfactants and cationic surfactants are particularly used. A nonionic surfactant may be used in combination with an anionic surfactant or a cationic surfactant.

The surfactants may be used alone or in combination of two or more types thereof.

Regarding the resin particle dispersion, examples of a dispersing method of the resin particles in a dispersion medium include common dispersing methods using a rotary shearing-type homogenizer, a ball mill, a sand mill, or a DYNO mill having a medium. In addition, depending on the type of the resin particles, resin particles may be dispersed in the resin particle dispersion using, for example, a phase inversion emulsification method.

The phase inversion emulsification method is a method in which a resin to be dispersed is dissolved in a hydrophobic organic solvent in which the resin is soluble, neutralization is performed by adding a base to the organic continuous phase (O phase), and then, an aqueous medium (W phase) is charged thereinto, so that the resin is converted (so-called phase inversion) from W/O to O/W to form a discontinuous phase, whereby the resin is dispersed in a particle form in the aqueous medium.

The volume average particle diameter of the resin particles dispersed in the resin particle dispersion is, for example, preferably from 0.01 μm to 1 μm, more preferably from 0.08 μm to 0.8 μm, and still more preferably from 0.1 μm to 0.6 μm.

Regarding the volume average particle diameter of the resin particles, a cumulative distribution by volume is drawn from the side of the smallest diameter with respect to particle diameter ranges (channels) separated using the particle diameter distribution obtained by the measurement of a laser diffraction-type particle diameter distribution measuring device (for example, LA-700, manufactured by Horiba, Ltd.), and the particle diameter when the volume becomes 50% with respect to the entirety of the particles is taken as a volume average particle diameter D50v. The volume average particle diameter of the particles in other dispersions is also measured in the same manner.

The content of the resin particles included in the resin particle dispersion is, for example, preferably from 5% by weight to 50% by weight, and more preferably from 10% by weight to 40% by weight.

A release agent dispersion and a colorant dispersion are also prepared in the same manner as in the preparing method of the resin particle dispersion. That is, the dispersion mediums, the surfactants, the dispersing methods, the volume average particle diameters of the particles, and the contents of the particles, of the release agent dispersion and the colorant dispersion are the same as those of the resin particle dispersion.

Brilliant Pigment Dispersion Preparation Step

According to the brilliant pigment dispersion preparation step, a pigment dispersion in which a brilliant pigment is dispersed is prepared.

The brilliant pigment dispersion is prepared by, for example, dispersing a brilliant pigment in a dispersion medium by a surfactant. Examples of the dispersion medium of the brilliant pigment dispersion include aqueous mediums. Examples of the aqueous mediums include water such as distilled water and ion exchange water; alcohols; and mixtures thereof.

Examples of the surfactant include anionic surfactants such as sulfuric ester salt, sulfonate, phosphate ester, and soap; cationic surfactants such as amine salt and quarternary ammonium salt; and nonionic surfactants such as polyethylene glycol, alkyl phenol ethylene oxide adduct, and polyols. The surfactants may be used alone or in combination of two or more types thereof.

Examples of the dispersing method of the brilliant pigment in a dispersion medium include general dispersing methods using a rotary shearing-type homogenizer, or a ball mill, a sand mill, a DYNO mill or the like, each having a medium.

The volume average particle diameter of the particles dispersed in the brilliant particle dispersion is, for example, preferably from 0.5 μM to 15 μm, more preferably from 1.5 μm to 10 μm, and still more preferably from 2 μm to 8 μm. The content of the particles included in the brilliant particle dispersion is, for example, preferably from 5% by weight to 50% by weight, and more preferably from 10% by weight to 40% by weight.

First Aggregated Particle Forming Step and Second Aggregated Particle Forming Step

In the first aggregated particle forming step, the resin particle dispersion (first resin particle dispersion) and the brilliant pigment dispersion are mixed, and the resin particles and the brilliant pigment are hetero-aggregated in the mixed dispersion, whereby the first aggregated particles including the resin particles and the brilliant pigment is formed.

In the second aggregated particle forming step, the resin particles are aggregated in the resin particle dispersion (second resin particle dispersion), whereby the second aggregated particles are formed.

In any of the above steps, by mixing the release agent dispersion and the colorant dispersion in, a release agent and a colorant may be included in the first aggregated particles and the second aggregated particles. The first resin particle dispersion and the second resin particle dispersion may be include a same type of resin, or may be include a different type of resin.

Formation of the aggregated particles is performed, for example, by adding an aggregating agent while stirring the dispersion at room temperature (for example, 25° C.) using a rotary shearing-type homogenizer and thereby aggregating the particles dispersed in the dispersion. At this time, as necessary, addition of a dispersion stabilizer; pH adjustment of the dispersion (for example, adjustment to from pH 2 to pH 5); or heating of the dispersion, specifically, heating to a temperature close to the glass transition temperature of the resin particles (for example, from a temperature 30° C. lower than the glass transition temperature of the resin particles to a temperature 10° C. lower than the glass transition temperature) may be performed.

In the aggregated particle forming step, the particle diameters of the aggregated particles are controlled by adjusting the above conditions, and therefore, it is possible to control the particle diameters of the obtained toner particles.

Examples of the aggregating agent include a surfactant having opposite polarity to that of the surfactant included in the dispersion, an inorganic metal salt, and a divalent or higher metal complex. In a case where the metal complex is used as the aggregating agent, the amount of the surfactant used is reduced, and charging characteristics are improved.

An additive which forms a complex with the metal ions of an aggregating agent or a similar bond may be used together with the aggregating agent. A chelating agent is suitably used as the additive.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight or greater to less than 3.0 parts by weight, with respect to 100 parts by weight of the resin particles.

Aggregation Promoting Step

Next, the aggregated particle dispersion (first aggregated particle dispersion) in which the first aggregated particles are dispersed and the aggregated particle dispersion (second aggregated particle dispersion) in which the second aggregated particles are dispersed are mixed, and, in the mixed dispersion, aggregation of the first aggregated particles and aggregation of the second aggregated particles are promoted.

By adjusting the mixing ratio between the first aggregated particle dispersion and the second aggregated particle dispersion, it is possible to control the proportion of the non-brilliant toner particles in the entirety of toner particles. In order to make the proportion of the non-brilliant toner particles in the entirety of toner particles be within a range of from 5% by number to 80% by number, the resin in the first aggregated particles and the resin in the second aggregated particles are preferably mixed so as to become a ratio by weight (the resin in the first aggregated particles:the resin in the second aggregated particles) from 3:97 to 48:52. The ratio is more preferably from 6:94 to 30:70, and still more preferably from 9:91 to 24:76.

Promotion of aggregation of the aggregated particles is performed by, for example, raising the temperature of the mixed dispersion to a temperature close to the glass transition temperature of the resin particles (for example, from a temperature 30° C. lower than the glass transition temperature of the resin particles to a temperature 10° C. lower than the glass transition temperature) by heating while stirring the mixed dispersion. At this time, as necessary, addition of an aggregating agent; addition of a dispersion stabilizer; or pH adjustment of the mixed dispersion (for example, adjustment to from pH 2 to pH 5) may be performed.

Coalescing Step

Next, the first aggregated particles and the second aggregated particles are respectively coalesced by heating the aggregated particle dispersion through the aggregation promoting step, whereby brilliant toner particles and non-brilliant toner particles are formed. Specifically, the aggregated particle dispersion is heated to, for example, a temperature that is equal to or higher than the glass transition temperature of the resin particles (for example, a temperature that is higher than the glass transition temperature of the resin particles by from 10° C. to 30° C.). In the coalescing step, for example, by using a stirring blade (for example, two paddles) for forming a laminar flow and by adjusting the stirring speed, it is possible to control the circularity distribution of the toner particles. Specifically, by increasing the stirring speed of the stirring blade to thereby add stronger shear force, it is possible to increase the circularity of the non-brilliant toner particles, and in order to make 80% by number or greater of the non-brilliant toner particles have a circularity of 0.950 or greater, it is preferable that the stirring speed is within a range of from 2,000 rpm to 3,000 rpm.

Toner particles are obtained through the above steps.

Moreover, the toner particles having a core/shell structure may be formed by further mixing the resin particle dispersion in which resin particles are dispersed with the aggregated particle dispersion obtained through the aggregation promoting step to thereby aggregate the resin particles such that the resin particles are further attached to each surface of the first aggregated particles and the second aggregated particles, and then heating the aggregated particle dispersion.

The volume average particle diameter of the toner particles may be controlled by adjusting various conditions of the aggregated particle forming step and the aggregation promoting step. Specifically, aggregated particles having a diameter close to the diameter of the toner particles of interest are formed by adjusting the amount of an aggregating agent added, the stirring conditions, the heating temperature, and the heating time.

After the coalescing step ends, the toner particles formed in the solution are subjected to a washing step, a solid-liquid separating step, and a drying step, that are well known, whereby dried toner particles are obtained.

In the washing step, displacement washing using ion exchange water may be sufficiently performed from the viewpoint of charging properties. In addition, the solid-liquid separating step is not particularly limited, but suction filtration, pressure filtration, or the like may be performed from the viewpoint of productivity. In addition, the method for the drying step is also not particularly limited, but freeze drying, flash jet drying, fluidized drying, vibration-type fluidized drying, or the like may be performed from the viewpoint of productivity.

In addition, the toner according to the exemplary embodiment is prepared by, for example, adding an external additive to and mixing with the dried toner particles. The mixing may be performed using, for example, a V-blender, a HENSCHEL mixer, a LÖDIGE mixer, or the like. Furthermore, as necessary, coarse toner particles may be removed using a vibration sieving machine, a wind classifier, or the like.

Electrostatic Charge Image Developer

An electrostatic charge image developer according to the exemplary embodiment includes at least the toner according to the exemplary embodiment. The electrostatic charge image developer according to the exemplary embodiment may be a single-component developer including only the toner according to the exemplary embodiment or a two-component developer obtained by mixing the toner with a carrier.

The carrier is not particularly limited, and known carriers are exemplified. Examples of the carrier include a coating carrier in which surfaces of cores formed of magnetic particles are coated with a resin; a magnetic particle dispersion-type carrier in which magnetic particles are dispersed and blended in a matrix resin; and a resin impregnation-type carrier in which porous magnetic particles are impregnated with a resin. The magnetic particle dispersion-type carrier and the resin impregnation-type carrier may be carriers in which constituent particles of the carriers are cores and have surfaces coated with a resin.

Examples of the magnetic particles include magnetic metals such as iron, nickel, and cobalt; and magnetic oxides such as ferrite and magnetite.

Examples of the resin for coating and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin. Moreover, the resin for coating and the matrix resin may include an additive such as a conductive material. Examples of the conductive particles include particles of metals such as gold, silver, and copper; and particles of carbon black, titanium oxide, zinc oxide, tin oxide, barium sulfate, aluminum borate, or potassium titanate.

A coating method using a coating layer forming solution obtained by dissolving a resin for coating and various additives (which are used as necessary) in a suitable solvent to coat the surface of a core with the resin is exemplified. The solvent is not particularly limited, and may be selected in consideration of the type of the resin to be used, application suitability, and the like. Specific examples of the resin coating method include a dipping method for dipping cores in a coating layer forming solution; a spraying method for spraying a coating layer forming solution to surfaces of cores; a fluid bed method for spraying a coating layer forming solution in a state in which cores are allowed to float by flowing air; and a kneader-coater method in which cores of a carrier and a coating layer forming solution are mixed with each other in a kneader-coater and the solvent is removed.

The mixing ratio by weight (toner:carrier) between the toner and the carrier in the two-component developer is preferably from 1:100 to 30:100, and more preferably from 3:100 to 20:100.

Image Forming Apparatus/Image Forming Method

The image forming apparatus and the image forming method according to the exemplary embodiment will be described.

The image forming apparatus according to the exemplary embodiment is equipped with an image holding member, a charging unit that charges a surface of the image holding member, an electrostatic charge image forming unit that forms an electrostatic charge image on a charged surface of the image holding member, a developing unit that contains an electrostatic charge image developer and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium. In addition, as the electrostatic charge image developer, the electrostatic charge image developer according to the exemplary embodiment is applied.

In the image forming apparatus according to the exemplary embodiment, an image forming method (image forming method according to the exemplary embodiment) including a charging step of charging a surface of an image holding member, an electrostatic charge image forming step of forming an electrostatic charge image on the charged surface of the image holding member, a developing step of developing the electrostatic charge image formed on the surface of the image holding member with the electrostatic charge image developer according to the exemplary embodiment to form a toner image, a transfer step of transferring the toner image formed on the surface of the image holding member onto a surface of a recording medium, and a fixing step of fixing the toner image transferred onto the surface of the recording medium is performed.

As the image forming apparatus according to the exemplary embodiment, a known image forming apparatus is applied, such as a direct transfer-type apparatus that directly transfers a toner image formed on a surface of an image holding member onto a recording medium; an intermediate transfer-type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus that is provided with a cleaning unit that cleans a surface of an image holding member after transfer of a toner image and before charging; or an apparatus that is provided with an charge removing unit that irradiates, after transfer of a toner image and before charging, a surface of an image holding member with charge removing light for removing charge.

In the case where the image forming apparatus according to the exemplary embodiment is an intermediate transfer-type apparatus, the transfer unit has, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to the exemplary embodiment, for example, a part including the developing unit may have a cartridge structure (process cartridge) that is detachable from the image forming apparatus. As the process cartridge, for example, a process cartridge that contains the electrostatic charge image developer according to the exemplary embodiment and is equipped with a developing unit is suitably used.

Hereinafter, an example of the image forming apparatus according to the exemplary embodiment will be described; however, this image forming apparatus is not limited thereto. In the following description, major portions shown in the drawing will be described, and description of other portions will be omitted. In the following description, a case where the toner according to the exemplary embodiment is a silver toner will be described as an example; however, the toner is not limited thereto.

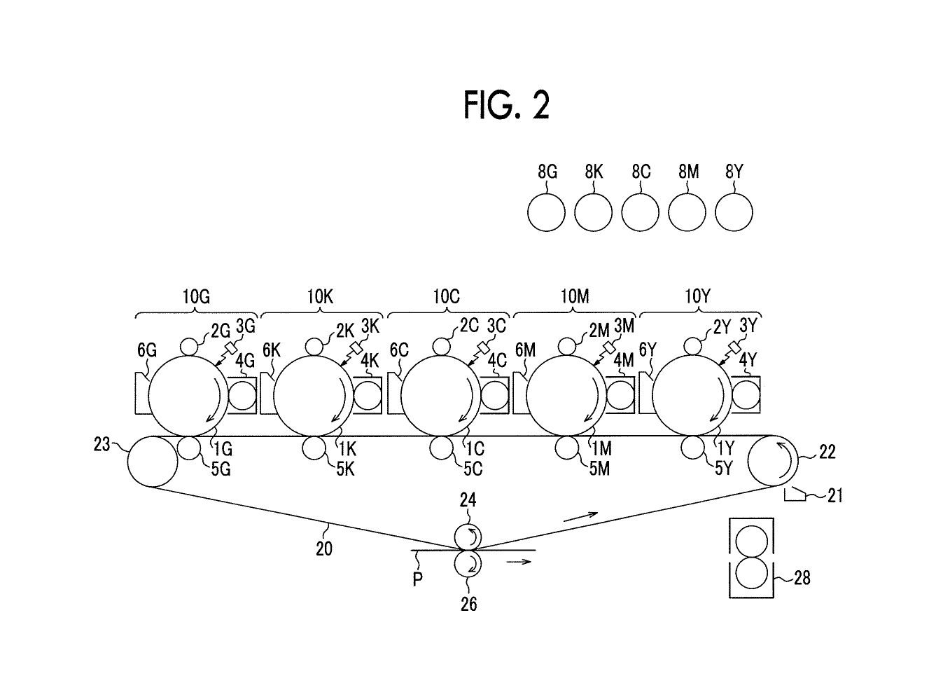

FIG. 2 is a configuration diagram showing the image forming apparatus according to the exemplary embodiment, and is a diagram showing a five tandem system-type and intermediate transfer-type image forming apparatus.

The image forming apparatus shown in FIG. 2 is equipped with first to fifth electrophotographic image forming units 10Y, 10M, 100, 10K, and 10G (image forming units) that output yellow (Y), magenta (M), cyan (C), black (K), and silver (G) images based on color-separated image data, respectively. These image forming units (hereinafter, simply referred to as “units” in some cases) 10Y, 10M, 100, 10K, and 10G are arranged side by side at predetermined intervals in a horizontal direction. These units 10Y, 10M, 100, 10K, and 10G may be process cartridges that are detachable from the image forming apparatus.

An intermediate transfer belt (an example of the intermediate transfer member) 20 is extended through each unit on the lower side of each unit of 10Y, 10M, 100, 10K, and 10G. The intermediate transfer belt 20 is provided so as to be wound on a drive roll 22, a support roll 23, and an opposing roll which are in contact with the inner surface of the intermediate transfer belt 20, and so as to run in the direction toward the fifth unit 10G from the first unit 10Y. An intermediate transfer member cleaning device 21 is equipped so as to face the drive roll 22 on the image holding surface side of the intermediate transfer belt 20.

Each toner of yellow, magenta, cyan, black, and silver contained in toner cartridges of 8Y, 8M, 8C, 8K, and 8G is supplied to each of developing devices (an example of developing unit) 4Y, 4M, 4C, 4K, and 4G of each unit of 10Y, 10M, 100, 10K, and 10G.

Since the first to fifth units 10Y, 10M, 100, 10K, and 10G have the same configuration, operation, and action, here, only the first unit 10Y for forming a yellow image which is disposed on the upstream side in the intermediate transfer belt running direction will be described as a representative example.

The first unit 10Y has a photoreceptor 1Y acting as an image holding member. Around the photoreceptor 1Y, a charging roll (an example of the charging unit) 2Y that charges a surface of the photoreceptor 1Y to a predetermined potential, an exposure device (an example of the electrostatic charge image forming unit) 3Y that exposes the charged surface with laser beams based on a color-separated image signal to form an electrostatic charge image, a developing device (an example of the developing unit) 4Y that supplies a toner to the electrostatic charge image to develop the electrostatic charge image, a primary transfer roll (an example of the primary transfer unit) 5Y that transfers the developed toner image onto the intermediate transfer belt 20, and a photoreceptor cleaning device (an example of the cleaning unit) 6Y that removes the toner remaining on the surface of the photoreceptor 1Y after primary transfer, are disposed in sequence.

The primary transfer roll 5Y is disposed inside the intermediate transfer belt 20 and provided at a position opposed to the photoreceptor 1Y. Bias power source (not shown) that apply a primary transfer bias is connected to each of the primary transfer rolls 5Y, 5M, 5C, 5K, and 5G, respectively. Each bias power source changes the value of a transfer bias to be applied to each primary transfer roll by control by a control portion not shown in the drawing.

Hereinafter, the operation for forming a yellow image in the first unit 10Y will be described.

First, before the operation, the surface of the photoreceptor 1Y is charged to a potential from −600 V to −800 V by the charging roll 2Y.

The photoreceptor 1Y is formed by laminating a photosensitive layer on a conductive substrate (for example, volume resistivity at 200 of 1×10⁻⁶ Ωcm or less). The photosensitive layer typically has high resistance (resistance of a general resin), but has properties in which when laser beams are applied, the specific resistance of apart irradiated with the laser beams changes. Accordingly, the laser beams are output to the charged surface of the photoreceptor 1Y through the exposure device 3Y in accordance with the image data for yellow transmitted from the control portion not shown in the drawing. As a result, an electrostatic charge image having a yellow image pattern is formed on the surface of the photoreceptor 1Y.

The electrostatic charge image is an image that is formed on the surface of the photoreceptor 1Y by charging, and is a so-called negative latent image, that is formed in the manner in which specific resistance of the irradiated part of the photosensitive layer is decreased by the laser beam from the exposure device 3Y, charges charged on the surface of the photoreceptor 1Y flows, and, on the other hand, the charge of the part which is not irradiated with the laser beam remains.

The electrostatic charge image formed on the photoreceptor 1Y is rotated up to a predetermined developing position according to the running of the photoreceptor 1Y. In addition, the electrostatic charge image on the photoreceptor 1Y is visualized by being developed as a toner image at the developing position by the developing device 4Y.

The developing device 4Y contains, for example, an electrostatic charge image developer accommodating at least a yellow toner and a carrier. The yellow toner is frictionally charged by being stirred in the developing device 4Y to have a charge with the same polarity (negative polarity) as the charge that is on the photoreceptor 1Y, and is thus held on the developer roll (an example of the developer holding member). By allowing the surface of the photoreceptor 1Y to pass through the developing device 4Y, the yellow toner electrostatically attaches to the latent image portion discharged on the surface of the photoreceptor 1Y, whereby the latent image is developed by the yellow toner. The photoreceptor 1Y on which a yellow toner image is formed is run continuously at a predetermined speed, and the toner image developed on the photoreceptor 1Y is transported to a predetermined primary transfer position.

When the yellow toner image on the photoreceptor 1Y is transported to the primary transfer position, a primary transfer bias is applied to the primary transfer roll 5Y and an electrostatic force toward the primary transfer roll 5Y from the photoreceptor 1Y acts on the toner image, whereby the toner image on the photoreceptor 1Y is transferred onto the intermediate transfer belt 20. The transfer bias applied at this time has the opposite polarity (+) to the toner polarity (−), and is controlled to, for example, +10 μA in the first unit 10Y by the control portion (not shown).

On the other hand, the toner remaining on the photoreceptor 1Y is removed by the photoreceptor cleaning device 6Y and collected.

The primary transfer biases that are applied to the primary transfer rolls 5M, 5C, 5K, and 5G of the second unit 10M and the subsequent units are also controlled in the same manner as in the case of the first unit.

In this manner, the intermediate transfer belt 20 onto which the yellow toner image is transferred in the first unit 10Y is sequentially transported through the second to fifth units 10M, 100, 10K, and 10G and the toner images of respective colors are multiply-transferred in a superimposed manner.

The intermediate transfer belt 20 onto which the five color toner images are multiply-transferred through the first to fifth units reaches a secondary transfer portion that is configured of the intermediate transfer belt 20, the opposing roll 24 contacting the inner surface of the intermediate transfer belt, and a secondary transfer roll (an example of the secondary transfer unit) 26 disposed on the image holding surface side of the intermediate transfer belt 20. Meanwhile, a recording sheet (an example of the recording medium) P is supplied to a gap between the secondary transfer roll 26 and the intermediate transfer belt 20, that are brought into contact with each other, through a supply mechanism at a predetermined timing, and a secondary transfer bias is applied to the opposing roll 24. The transfer bias applied at this time has the same polarity (−) as the toner polarity (−), and an electrostatic force toward the recording sheet P from the intermediate transfer belt 20 acts on the toner image, whereby the toner image on the intermediate transfer belt 20 is transferred onto the recording sheet P. In this case, the secondary transfer bias is determined depending on the resistance detected by a resistance detecting unit (not shown) that detects the resistance of the secondary transfer portion, and is voltage-controlled.

Thereafter, the recording sheet P is fed to a pressure-contacting portion (nip portion) between a pair of fixing rolls in a fixing device (an example of the fixing unit) 28 so that the toner image is fixed to the recording sheet P, whereby a fixed image is formed.

Examples of the recording sheet P on which a toner image is transferred include plain paper that is used in electrophotographic copying machines, printers, and the like. As the recording medium, an OHP paper is also exemplified other than the recording sheet P.

The surface of the recording sheet P is preferably smooth in order to further improve smoothness of the image surface after fixing, and, for example, coating paper obtained by coating a surface of plain paper with a resin or the like, art paper for printing, and the like are suitably used.

The recording sheet P on which the fixing of the color image is completed is discharged toward a discharge portion, and a series of the color image forming operations end.

Process Cartridge/Toner Cartridge

The process cartridge according to the exemplary embodiment will be described.

The process cartridge according to the exemplary embodiment is equipped with a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing unit, and if necessary, at least one selected from other units such as an image holding member, a charging unit, an electrostatic charge image forming unit, and a transfer unit.

Hereinafter, an example of the process cartridge according to the exemplary embodiment will be shown, but, this process cartridge is not limited thereto. In the following description, the major portions shown in the drawing will be described, and description of other portions will be omitted.

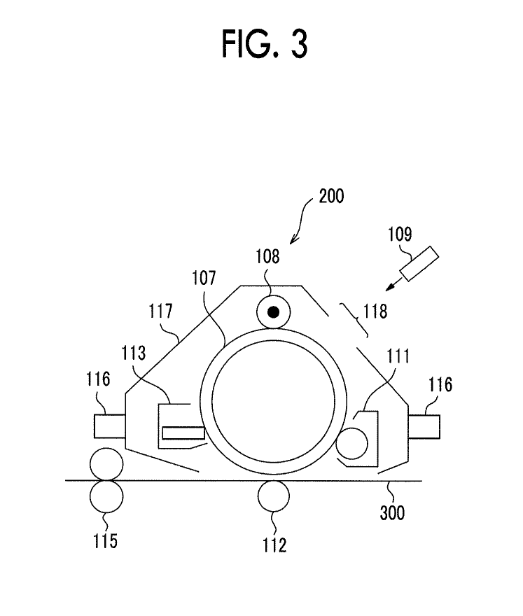

FIG. 3 is a schematic diagram showing a configuration of the process cartridge according to the exemplary embodiment.

A process cartridge 200 shown in FIG. 3 is formed as a cartridge having a configuration in which a photoreceptor 107 (an example of the image holding member), a charging roll 108 (an example of the charging unit), a developing device 111 (an example of the developing unit), and a photoreceptor cleaning device 113 (an example of the cleaning unit), which are equipped around the photoreceptor 107, are integrally combined and held by the use of, for example, a housing 117 equipped with a mounting rail 116 and an opening portion 118 for exposure.

In FIG. 3, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, the toner cartridge according to the exemplary embodiment will be described.

The toner cartridge according to the exemplary embodiment accommodates the toner according to the exemplary embodiment and is detachable from an image forming apparatus. The toner cartridge accommodates a toner for replenishment for being supplied to the developing unit provided in the image forming apparatus.

The image forming apparatus shown in FIG. 2 is an image forming apparatus that has such a configuration that the toner cartridges 8Y, 8M, 8C, 8K, and 8G are detachably attached thereto, and the developing apparatuses 4Y, 4M, 4C, 4K, and 4G are connected to the toner cartridges corresponding to the respective colors through toner supply tubes (not shown), respectively. In addition, in a case where the toner contained in the toner cartridge runs low, the toner cartridge is replaced.

### EXAMPLES

Hereinafter, the present invention will be further specifically described with reference to Examples; however, the present invention is not limited to the following Examples as long as it does not depart from the scope thereof.

Hereafter, “parts” and “%” are based on weight unless otherwise specifically indicated.

### Example 1

### Synthesis of Binder Resin

Dimethyl adipate: 74 parts
Dimethyl terephthalate: 192 parts
Bisphenol A ethylene oxide 2 moles adduct: 216 parts
Ethylene glycol: 38 parts
Tetrabutoxy titanate (catalyst): 0.037 parts

The above materials are put into a two-neck flask dried by heating, then, nitrogen gas is charged into the flask to make an inert atmosphere, and after the temperature is raised while stirring, a co-condensation polymerization reaction is performed at 160° C. for 7 hours, then, the temperature is raised to 220° C. while slowly reducing the pressure to 10 Torr, and the resultant product is kept for 4 hours. After the pressure is returned to atmospheric pressure (1 atom), 9 parts of trimellitic anhydride is added thereto, then, the pressure is slowly reduced to 10 Torr again, and the resultant product is kept at 220° C. for 1 hour, whereby a binder resin is synthesized.

Preparation of Resin Particle Dispersion
Binder resin: 160 parts
Ethyl acetate: 233 parts
Sodium hydroxide aqueous solution (0.3 N): 0.1 parts

The above materials are put into a 1,000 mL separable flask, are heated to 70° C., and stirred using a three-one motor (manufactured by Shinto Scientific Co., Ltd.), whereby a resin mixed solution is prepared. 373 parts of ion exchange water is slowly added to the resin mixed solution while further stirring, then, the resultant product is subjected to phase inversion emulsification, and the solvent thereof is removed, whereby a resin particle dispersion (solid content concentration of 30%) is prepared.

Preparation of Release Agent Dispersion
Carnauba wax (RC-160 manufactured by Toa Kasei Co., Ltd.): 50 parts
Anionic surfactant (NEOGEN RK manufactured by Dai-ichi Kogyo Seiyaku Co., Ltd.): 1.0 part
Ion exchange water: 200 parts

The above materials are mixed, and after the mixture is heated to 95° C. and dispersed using a homogenizer (ULTRA TURRAX T50 manufactured by IKA Japan, K.K.), the resultant product is subjected to a dispersion treatment for 6 hours using a manton gaulin type high pressure homogenizer (manufactured by Gaulin), whereby a release agent dispersion (solid content concentration of 20%) formed by dispersing release agent particles having an volume average particle diameter of 0.23 is prepared.

Preparation of Brilliant Pigment Dispersion
Aluminum pigment (2173EA manufactured by Showa Aluminum Corporation): 100 parts
Anionic surfactant (manufactured by Dai-ichi Kogyo Seiyaku Co., Ltd., NEOGEN R): 1.5 parts
Ion exchange water: 900 parts

After the solvent is removed from the paste of the aluminum pigment, the above materials are mixed, and the mixture is dispersed for 1 hour using an emulsifying disperser CAVITRON (CR1010 manufactured by Pacific Machinery & Engineering Co., Ltd.), whereby a brilliant pigment dispersion (solid content concentration of 10%) formed by dispersing the brilliant pigment (aluminum pigment) is prepared.

Preparation of Toner Particles
Resin particle dispersion (first resin particle dispersion): 212.5 parts
Release agent dispersion: 25 parts
Brilliant pigment dispersion: 100 parts
Nonionic surfactant (IGEPAL CA897): 1.40 parts

The above materials are put into a 2L cylindrical stainless container, and the materials are dispersed and mixed for 10 minutes while applying a shear force at 4,000 rpm by a homogenizer (ULTRA TURRAX T50 manufactured by IKA Japan, K.K.). Next, 1.75 parts of 10% nitric acid aqueous solution of polyaluminum chloride as an aggregating agent are slowly added dropwise thereto, and the resultant product is dispersed and mixed for 15 minutes at a rotation rate of 5,000 rpm of the homogenizer, whereby a first aggregated particle dispersion is prepared. Preparation of the dispersion is performed while checking the size and the shape of the particles with an optical microscope.

Next, a second aggregated particle dispersion is prepared in the same manner as described above using 37.5 parts of the resin particle dispersion (second resin particle dispersion), without using the brilliant pigment dispersion. Preparation of the dispersion is performed while checking the size and the shape of the particles with an optical microscope.

Next, the first aggregated particle dispersion and the second aggregated particle dispersion are mixed. The mixed dispersion is transferred to a polymerization tank equipped with a stirrer using two paddle stirring blades for forming a laminar flow and a thermometer, then, heated with a mantle heater at a stirring rate of 500 rpm, and the temperature is adjusted to 54° C. to promote growth of aggregated particles. At this time, the pH of the dispersion is controlled to a range of from 2.2 to 3.5 with a 0.3 N nitric acid aqueous solution or a 1 N sodium hydroxide aqueous solution. The dispersion is kept within the above pH range for about 2 hours.

Next, 33.3 parts of the resin particle dispersion is additionally added thereto, whereby the resin particles are attached to the surface of the aggregated particles. The temperature is raised to 56° C., and the aggregated particles are adjusted while checking the size and shape of particles using an optical microscope and MULTISIZER II (manufactured by Beckman Coulter Inc.).

Thereafter, in order to make the aggregated particles coalesce, the pH is raised to 8.0 and the temperature is raised to 72.5° C. After the temperature is raised, the resultant dispersion is kept for 1.5 hours at a stirring rate of 2,700 rpm. After it is confirmed that the aggregated particles coalesce using an optical microscope, the pH is lowered to 6.0 while keeping at the temperature of 72.5° C., and the resultant dispersion is kept for one hour. Then, heating is stopped, and cooling is performed at a temperature cooling rate of 1.0° C./min. Thereafter, the resultant product is sieved with a 40 μm mesh, then, repeatedly washed with water, and dried in a vacuum dryer, whereby toner particles (particle group including brilliant toner particles and non-brilliant toner particles) are obtained.

Measurement

Using a dispersion obtained by dispersing the obtained toner particles in COULTER ISOTON II Diluent (manufactured by Beckman Coulter Inc.) as a sample, the brilliant toner particles and the non-brilliant toner particles are analyzed by means of a flow-type particle image analyzer FPIA-3000 (manufactured by Sysmex Corporation). When the toner particles are analyzed, for the purpose of measurement noise removal, the particle diameter analysis range is set to 0.5 pinto 50 μm, and the circularity analysis range is set to 0.700 to 1.00.

Preparation of Toner Including an External Additive 1.5 parts of hydrophobic silica (RY50, manufactured by Nippon Aerosil Co., Ltd.), and 1.0 part of hydrophobic titanium oxide (T805, manufactured by Nippon Aerosil Co., Ltd.), which each is an external additive, are added to 100 parts of the toner particles and are mixed for 30 seconds at 10,000 rpm using a sample mill. Hereafter, the resultant product is sieved with a vibration sieving machine having a mesh of 45 μm, whereby the toner including not only the toner particles but also the external additives is obtained as a toner including an external additive.

Preparation of Carrier
Ferrite particles (volume average particle diameter of 35 μm): 100 parts
Toluene: 14 parts
Perfluorooctyl ethyl acrylate-methyl methacrylate copolymer (critical surface tension of 24 dyn/cm, copolymerization ratio of 2:8, weight average molecular weight of 77,000): 1.6 parts
Carbon black (trade name: VXC-72, manufactured by Cabot Corporation, volume resistivity of 100 Ωcm or less): 0.12 parts
Crosslinked melamine resin particles (average particle diameter of 0.3 μm, insoluble in toluene): 0.3 parts

Carbon black diluted with toluene is added to the perfluorooctyl ethyl acrylate-methyl methacrylate copolymer, and the resultant product is dispersed using a sand mill. Then, the crosslinked melamine resin particles are dispersed therein using a stirrer for 10 minutes, whereby a solution for forming a coating layer is prepared. Then, the solution for forming a coating layer and the ferrite particles are put into a vacuum deaeration-type kneader, and after stirring at a temperature of 60° C. for 30 minutes, the toluene is distilled off (removed by evaporation) by reducing the pressure, whereby a resin-coated carrier is obtained.

Preparation of Developer

36 parts of the toner including an external additive and 414 parts of the carrier are put into a 2 L V-blender, then, the mixture is stirred for 20 minutes, and sieved with a sieve of 212 μm mesh, whereby a developer is obtained.

Evaluation

A developing apparatus of a modifier of a DOCUCENTRE-III C7600 manufactured by Fuji Xerox Co., Ltd. is filled with the prepared developer, and the following evaluation tests are performed. The modifier is a developing apparatus modified such that the apparatus is forcibly stopped before each step is completed in order to measure the amount of each toner on the photoreceptor, the intermediate transfer member, and the paper (unfixed). The evaluation results are shown in Table 1.

Transfer Properties

After 10,000 sheets of patches of 5 cm×5 cm having a toner applied amount of 4.5 g/m² are formed on paper (C2 paper manufactured by Fuji Xerox Co., Ltd.) in an environment of 32° C. and 80% RH, the amount of each toner on the photoreceptor, the intermediate transfer member, and the paper (unfixed) is measured, and primary transfer efficiency, secondary transfer efficiency, and transfer properties are calculated according to the following equations. Transfer properties of 80% or greater is the acceptable level.

Primary transfer efficiency=(amount of toner on intermediate transfer member)/(amount of toner on photoreceptor)

Secondary transfer efficiency=(amount of toner unfixed on paper)/(amount of toner on intermediate transfer member)

Transfer properties (%)=(primary transfer efficiency)×(secondary transfer efficiency)×100

Brilliance, Ratio (A/B)

Using the developer after forming the 10,000 sheets used in the transfer properties evaluation, a solid image of 10 cm×10 cm having a toner applied amount of 4.5 g/m² is formed. The fixing temperature is set to 190° C., the fixing pressure is set to 4.0 kg/cm², and as the recording medium, OK topcoat+paper manufactured by Oji Paper Co., Ltd. is used.

For the obtained solid image, the brilliance is visually evaluated under lighting for color observation (natural daylight lighting) according to JIS K 5600-4-3: 1999 “Testing methods for paints—Part 4: Visual characteristics of film—Section 3: Visual comparison of the color of paints”. The particle feeling (glittering brilliance effect) and the optical effect (change in hue depending on the viewing angle) are observed, and the brilliance is evaluated according to the following evaluation criteria. Evaluation criteria of 2 of greater are the acceptable levels.

Evaluation Criteria

5: Particle feeling and an optical effect are exhibited, and both are in harmony with each other.

4: Particle feeling and an optical effect are exhibited, and the harmony of both is felt somewhat.

3: Each of particle feeling and an optical effect is felt.

2: Particle feeling and an optical effect are exhibited; however, it appears blurred.

1: Particle feeling and an optical effect are not exhibited at all.

In addition, for the obtained solid image, the ratio (A/B) is determined by the method described above.

Image Defect

Using the developer after forming the 10,000 sheets used in the transfer properties evaluation, 10,000 sheets of patches of 5 cm×5 cm having a toner applied amount of 4.5 g/m² are further formed on paper (C2 paper manufactured by Fuji Xerox Co., Ltd.) in an environment of 32° C. and 80% RH, and subsequently, one sheet is output with no image. The number of the color points on the paper is visually counted. A case where the color points are less than 10 points is the acceptable level.

### Examples 2 to 11 and Comparative Examples 1 to 3

Toner particles, toners including an external additive, and developers are prepared in the same manner as in Example 1 except that the number of parts of the first resin particle dispersion, the brilliant pigment dispersion, and the second resin particle dispersion, the stirring rate of the stirring blade in the coalescing step, the keeping temperature, and keeping time are changed as described in Table 1, and evaluations are performed in the same manner as in Example 1. The evaluation results are shown in Table 1.

Moreover, 21.7% by number of the brilliant toner particles of the Comparative Example 1 has a circularity greater than 0.940, and 0.3% by number thereof has a circularity less than 0.850.

TABLE 1

| | | | | | | | Brilliant toner particles | |
|---|---|---|---|---|---|---|---|---|
| | Preparing conditions of toner particles | | | | | | | Volume |
| | Amount of dispersion used (parts) | | | Coalescing step | | | Ratio of | average |
| | First resin | Brilliant | Second resin | Stirring | | | circularity of | particle |
| | particle | pigment | particle | rate | | | 0.850 to 0.940 | diameter |
| | dispersion | dispersion | dispersion | (rpm) | Temperature | Time | (% by number) | (μm) |
| Comparative | 212.5 | 100 | 37.5 | 500 | 75° C. | 3 h | 78% | 15.5 |
| Example 1 | | | | | | | | |
| Comparative | 250 | 100 | 0 | 500 | 67.5° C. | 1.5 h | 96% | 15.4 |
| Example 2 | | | | | | | | |
| Comparative | 212.5 | 100 | 37.5 | 500 | 67.5° C. | 1.5 h | 96% | 15.5 |
| Example 3 | | | | | | | | |
| Example 1 | 212.5 | 100 | 37.5 | 2700 | 72.5° C. | 1.5 h | 81% | 15.3 |
| Example 2 | 212.5 | 100 | 37.5 | 2700 | 67.5° C. | 1.5 h | 96% | 15.6 |
| Example 3 | 212.5 | 100 | 37.5 | 2700 | 70° C. | 1.5 h | 88% | 15.5 |
| Example 4 | 212.5 | 100 | 37.5 | 2050 | 67.5° C. | 1.5 h | 97% | 15.4 |
| Example 5 | 212.5 | 100 | 37.5 | 2300 | 67.5° C. | 1.5 h | 97% | 15.5 |
| Example 6 | 243.2 | 100 | 6.8 | 2700 | 67.5° C. | 1.5 h | 96% | 15.3 |
| Example 7 | 241.6 | 100 | 8.4 | 2700 | 67.5° C. | 1.5 h | 96% | 15.5 |
| Example 8 | 205.0 | 100 | 45.0 | 2700 | 67.5° C. | 1.5 h | 95% | 15.7 |
| Example 9 | 158.5 | 100 | 91.5 | 2700 | 67.5° C. | 1.5 h | 95% | 15.5 |
| Example 10 | 133.0 | 100 | 117.0 | 2700 | 67.5° C. | 1.5 h | 96% | 15.4 |
| Example 11 | 128.5 | 100 | 121.5 | 2700 | 67.5° C. | 1.5 h | 95% | 15.5 |

| | Non-brilliant toner particles | | Ratio of | | | | |
|---|---|---|---|---|---|---|---|
| | | Volume | non-brilliant | | | | |
| | Ratio of | average | toner | | | | |
| | circularity of | particle | particles | Evaluation | | | |
| | 0.950 or greater | diameter | (% by | Ratio | Transfer | | Image |
| | (% by number) | (μm) | number) | (A/B) | properties | Brilliance | defect |
| Comparative | 94% | 6.5 | 24% | 22 | 87% | 1 | 5 |
| Example 1 | | | | | | | |
| Comparative | — | | 0% | 58 | 65% | 3 | 56 |
| Example 2 | | | | | | | |
| Comparative | 77% | 6.6 | 25% | 20 | 85% | 4 | 13 |
| Example 3 | | | | | | | |
| Example 1 | 97% | 6.3 | 22% | 25 | 87% | 4 | 8 |
| Example 2 | 96% | 6.7 | 23% | 21 | 95% | 5 | 2 |
| Example 3 | 96% | 6.5 | 23% | 21 | 93% | 5 | 4 |
| Example 4 | 81% | 6.5 | 24% | 23 | 83% | 4 | 9 |
| Example 5 | 88% | 6.6 | 25% | 20 | 93% | 5 | 5 |
| Example 6 | 95% | 6.5 | 4% | 56 | 81% | 2 | 8 |
| Example 7 | 96% | 6.5 | 6% | 55 | 83% | 3 | 4 |
| Example 8 | 95% | 6.7 | 30% | 10 | 93% | 5 | 4 |
| Example 9 | 95% | 6.7 | 60% | 6 | 90% | 4 | 2 |
| Example 10 | 95% | 6.5 | 78% | 5 | 84% | 3 | 6 |
| Example 11 | 96% | 6.6 | 81% | 4 | 81% | 2 | 9 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
first particles containing a brilliant pigment and second particles not containing a brilliant pigment,
wherein 80% by number or greater of the first particles has a circularity in a range of from 0.850 to 0.940, and
80% by number or greater of the second particles has a circularity of 0.950 or greater.

2. The electrostatic charge image developing toner according to claim 1,
wherein the proportion of the second particles in the entirety of toner particles is in a range of from 5% by number to 80% by number.

3. The electrostatic charge image developing toner according to claim 1,
wherein the volume average particle diameter of the first particles is in a range of from 5 μm to 30 μm, and
the volume average particle diameter of the second particles is in a range of from 1 μm to 15 μm.

4. The electrostatic charge image developing toner according to claim 2,
wherein the volume average particle diameter of the first particles is in a range of from 5 μm to 30 μm, and
the volume average particle diameter of the second particles is in a range of from 1 μm to 15 μm.

5. The electrostatic charge image developing toner according to claim 1,
wherein the volume average particle diameter of the first particles is in a range of from 7 μm to 25 μm.

6. The electrostatic charge image developing toner according to claim 1,
wherein the volume average particle diameter of the second particles is in a range of from 3 μm to 12 μm.

7. The electrostatic charge image developing toner according to claim 1,
wherein the proportion of the second particles in the entirety of toner particles is in a range of from 8% by number to 40% by number.

8. The electrostatic charge image developing toner according to claim 1, which satisfies the following expression in the case of forming a solid image:
2≦A/B≦100
wherein A is the reflectance at a light receiving angle of +30° measured when irradiating with an incident light having an incident angle of −45° using a goniophotometer with respect to the image, and B is the reflectance at a light receiving angle of −30°.

9. The electrostatic charge image developing toner according to claim 1,
wherein the first particles have a flake shape, and an average equivalent circle diameter D of the first particles is greater than an average maximum thickness C of the first particles.

10. The electrostatic charge image developing toner according to claim 9,
wherein the first particles have a ratio (C/D) of the average maximum thickness C of the first particles to the average equivalent circle diameter D of the first particles in a range of from 0.001 to 0.300.

11. An electrostatic charge image developer comprising:
the electrostatic charge image developing toner according to claim 1; and
a carrier.

12. The electrostatic charge image developer according to claim 11,
wherein the electrostatic charge image developing toner has the proportion of the second particles in the entirety of toner particles in a range of from 5% by number to 80% by number.

13. A toner cartridge, which accommodates the electrostatic charge image developing toner according to claim 1 and is detachable from an image forming apparatus.

14. The toner cartridge according to claim 13,
wherein the electrostatic charge image developing toner has the proportion of the second particles in the entirety of toner particles in a range of from 5% by number to 80% by number.
